(19) United States
(12) Patent Application Publication
(10) Pub. No.: US 2024/0330139 A1
(43) Pub. Date: Oct. 3, 2024

(54) RESOURCE UTILIZATION METADATA AND DATA CONFIDENCE FABRICS

(71) Applicant: Dell Products L.P., Round Rock, TX (US)

(72) Inventors: Pankaj Pande, Carlingford (AU); Stephen J. Todd, North Andover, MA (US)

(21) Appl. No.: 18/193,345

(22) Filed: Mar. 30, 2023

(51) Int. Cl. G06F 11/30

(52) U.S. Cl. CPC G06F 11/3051; G06F 11/3055; G06F 11/3442; G06F 11/3452

(57) ABSTRACT

One example method includes monitoring, by a profiler at a node of a data confidence fabric, resource consumption of one or more resources by the node in connection with operations performed by the node, performing a check to determine if resource consumption by the node is within a specified range, and based on an outcome of the check, assigning, or adjusting, a confidence score for the resource consumption. The confidence score may be used as a basis to perform one or more actions concerning the node and its workloads.

### FIELD OF THE INVENTION

Embodiments of the present invention generally relate to data confidence fabrics (DCF). More particularly, at least some embodiments of the invention relate to systems, hardware, software, computer-readable media, and methods, for data confidence operations and configurations as they relate to resource utilization in a DCF.

### BACKGROUND

In a computing environment such as a DCF, edge devices consume a certain amount of computing resources, such as power, CPU (central processing unit) cycles, RAM, and other resources. At present however, there is a lack of understanding with respect to various questions relating to resource consumption and utilization, particularly in a DCF context. Such questions may include, for example: (i) can the current state of an overly consumed edge device X, that is, a device X that is consuming too much of one or more resources, be improved?; (ii) are there edge devices that are faulty insofar as they are consuming too much of a particular resource, such as power?; and (iii) are there edge devices which are constantly busy, such that their consumption of resources may be shortening the life of those resources?; (iv) to what extent, and how, does overutilization of a resource, or resources, by an edge device impact data confidence?

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example DCF in which an embodiment of the invention may be implemented.

FIG. 2 discloses aspects of an architecture for relating resource utilization to DCF considerations, according to an embodiment.

FIG. 3 discloses an example method, according to one embodiment.

FIG. 4 discloses an example computing entity configured and operable to perform any of the disclosed methods, processes, and operations.

### DETAILED DESCRIPTION OF SOME EXAMPLE EMBODIMENTS

Embodiments of the present invention generally relate to data confidence fabrics (DCF). More particularly, at least some embodiments of the invention relate to systems, hardware, software, computer-readable media, and methods, for data confidence operations and configurations as they relate to resource utilization in a DCF.

In one example embodiment, data may flow from a device such as an edge device into a DCF. The DCF may annotate the data with annotations, possibly in the form of DCF metadata, indicating, for example, that a TPM (trusted platform module) has added a device signature to the data and has verified a secure boot of that device, and further indicating that AuthZ/N software is currently in place, protecting the device and data against unauthorized access. A profiler deployed in the DCF may be monitoring resource utilization by the device from which the data is received. The profiler may determine, and report, that a ‘consumption’ DCF parameter, or simply a ‘consumption parameter,’ indicates that one or more aspects of resource consumption by the device are outside of established boundaries, and/or are otherwise problematic. As a result of having made this determination, the profiler may generate a corresponding report identifying the problems. The report from the profiler may cause generation of a DCF annotation indicating that a “Consumption” DCF parameter has thus failed to meet its confidence criteria. In an embodiment, the confidence score of the ‘Consumption’ DCF parameter may thus be set to zero (0) when resource consumption by the device is outside of a limit established for that device. When resource consumption by the device is within established limits for the device, the confidence score of the ‘Consumption’ DCF parameter may be set to one (1). In an embodiment then, the confidence score may be Boolean, that is, binary, rather than being expressed as an actual numerical score. Finally, the addition of the confidence score concerning the consumption parameter may increase an overall confidence score for the data, or leave the confidence score for the data unchanged. In an embodiment, the confidence score concerning the consumption parameter may have a negative value so that when added to the overall confidence score for the data, the negative value will decrease the overall confidence score.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that resource utilization, including overutilization, by a DCF element may be taken into consideration when determining a confidence score for data associated with that DCF element. An embodiment may enable an admin to identify and resolve problems related to resource utilization in a DCF. An embodiment may enable an enterprise to reduce capital and operating expenses relating to the implementation and operation of a DCF. Various other advantages of one or more example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of an Example Architecture and Environment

The following is a discussion of aspects of example operating environments for various embodiments of the invention. This discussion is not intended to limit the scope of the invention, or the applicability of the embodiments, in any way. In general, embodiments of the invention may be implemented in connection with systems, software, and components, that individually and/or collectively implement, and/or cause the implementation of, a data confidence fabric (DCF).

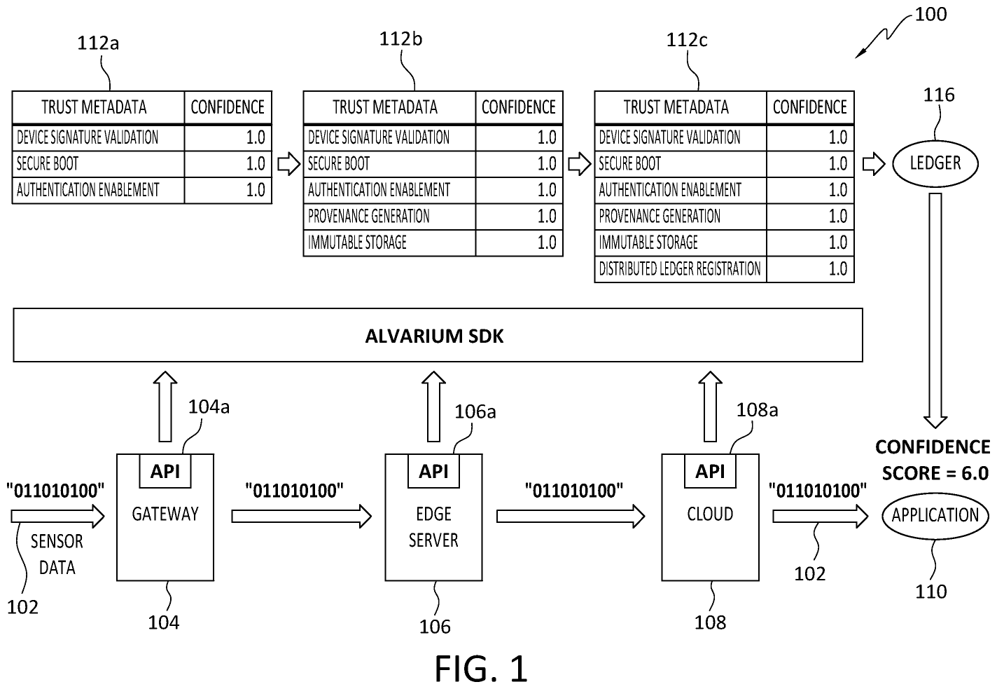

With reference now to FIG. 1, embodiments of the invention may be implemented in a variety of operating environments, one example of which is a DCF, denoted at 100 in FIG. 1. In general, the DCF 100 may annotate and score any data that flows within it, providing increased confidence to the applications that use that data, such as for analytical purposes for example.

As shown in FIG. 1, the example DCF 100 concerns the context of edge-based use cases, but the scope of the invention is not limited to such cases or contexts. As shown in the example of FIG. 1, data such as sensor data 102 generated by a sensor flows through one or more tiers, or layers, of the DCF. In the illustrated example, the data 102 may flow through nodes such as a gateway 104, edge server 106, and cloud ecosystem 108, and may ultimately be consumed by one or more applications 110. As trusted handling of the data 102, at the nodes of the various layers, occurs during data 102 delivery, respective trust metadata 112a, 112b, and 112c may be associated with the data 102 by those nodes, that is, by the gateway 104, edge server 106, and/or, cloud ecosystem 108. Thus, trust metadata may continue to accumulate as the data 102 passes through the various nodes in its path.

The trust metadata 112a, 112b, and 112c, may comprise, for example, respective confidence scores associated with trust insertion processes performed by the nodes with respect to the data 102. The trust metadata 112a, 112b, and 112c may be associated with the data 102 by respective node APIs (Application Program Interfaces) 104a, 106a, and 108a that communicate with an interface 114 such as an Alvarium SDK (Software Development Kit). After the data 102 has transited the various nodes, the final, comprehensive trust metadata 112c may be entered into a ledger 116 which may make the trust metadata 112c available for use by the applications 110. Note that, in this example, the trust metadata 112c is an accumulation of all the trust metadata respectively added by the gateway 104, edge server 106, and cloud ecosystem 108.

To illustrate with reference to the specific example of FIG. 1, the gateway 104 may annotate, to the data 102, respective trust metadata 112a for each of three different operations. Particularly, the gateway 104 may annotate trust metadata 112a that indicates, among other things: the gateway 104 has successfully validated the signature coming from the device that generated the data 102; the gateway 104 has used a TPM chip to confirm that the BIOS, firmware, or O/S on the gateway 104 was tampered with during boot; and, the gateway 104 is currently running authentication/authorization software to protect the data 102 stream from unwanted inspection or access. With continued reference to the trust metadata, including the trust metadata 112a, a Confidence score of “1.0” means that a trust insertion process, such as the secure boot confirmation for example, operation succeeded, while a score of “0,” for example, might indicate that signature validation failed, or was not performed for some reason.

As noted earlier, the DCF metadata, that is, the trust metadata 112a, ultimately arrives at the ledger 116, where a ledger entry may be created that permanently records the contents of the trust metadata 112a table as well as an overall Confidence Score, which is 6.0 in this illustrative example. Note that the equation used to calculate the Confidence Score in the example of FIG. 1 is simply a summation of confidence scores, but other approaches to calculating an overall Confidence Score may alternatively be employed.

A useful aspect of the example DCF 100 is that, as a result of the annotation of trust metadata 112a, 112b, and 112c, the application 110 may have access to additional context about the trustworthiness of the data 102, addressing the problem of potentially untrustworthy or malicious data sources. The problems presented by such data sources is increasingly faced by enterprise customers as they move their business logic closer to non-enterprise, and potentially untrustworthy, data sources at the edge and/or elsewhere. In the example DCF 100, the path of the data 102 may be largely software-dependent, in the sense that data path handling software, which may comprise a respective instance at each of the gateway 104, edge server 106, and cloud ecosystem 108, may call an annotation/scoring API 104a, 106a, and 108a, respectively, and routing software may be provided at these nodes that forwards the annotations along the data path. However, such software dependencies in a DCF, such as the DCF 100 for example, may lead to vulnerabilities in the trustworthiness of the actual DCF metadata, that is, the trust metadata 112a, 112b, and/or 112c, for example. Examples of such potential vulnerabilities are described below.

It is noted that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing. Example embodiments of the invention may be applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

### B. Aspects of Some Example Embodiments

In an embodiment, a Data Confidence Fabric (DCF) “Resource Consumption Score” (DCF-RCS) may be defined that may be used as the basis for generation of one or more confidence scores. The DCF-RS may be calculated and stored in any number of ways. Thus, one example embodiment may define and implement two confidence scores, namely, a first confidence score that pertains to data traffic that is flowing over the DCF, and a second confidence score that pertains to a DCF node that is handling the data. In both cases, respective confidence scores may be generated and used that apply to one, some, or all, nodes of a DCF.

In the case of the latter confidence score, pertaining to node resource consumption, that confidence score may be indicative of various status of a node such as, for example, (1) whether the node is, or is becoming, overburdened, that is, the node lacks the resources need to carry out its workload within parameters, such as may be specified in an SLA for example, and (2) whether the node is trending towards consuming, or is consuming, more resources than have been allocated to that node for performance of its tasks. Depending on the circumstances, the latter confidence score may indicate, for example, that a node is simply over-subscribed in terms of its resource consumption, and/or that there is a problem with the hardware/software of the node causing the node to behave in a particular way with respect to its resource consumption.

Thus, in an embodiment, a DCF-RCS measurement for a node may, for example, be 100% if that node is experiencing normal traffic and is not overburdened in any way. But if the data traffic coming into the node is measured to be excessive, or far out of the normal, or historical, range, the DCF-RCS measurement may be reduced. Similarly, if the life span of the parts on the node are noticed to be reaching their limit, the DCF-RCS measurement may be reduced accordingly. In an embodiment, the DCF-RCS measurements, which may comprise direct measurements of resource consumption, may be mapped to particular confidence values, which may be expressed in binary form. To illustrate, if a measurement indicates that a node is overconsuming a resource by 10 percent over an established limit, the corresponding confidence score may be zero (0), which may indicate that resource usage by the node is over the limit. Similarly, if a measurement indicates that a node is consuming 90 percent of available resources, as expressed by a resource appropriate metric, such as “X’ 1000 IOs for a processor, the corresponding confidence score may be one (1), which may indicate that resource usage by the node is within an acceptable range. Note that significant underconsumption of a resource, such as 5 percent of available resources, may indicate a problem with the node as well, such as a hardware/software problem, and the corresponding confidence score may be set to zero (0) to reflect that a problem may exist.

DCF-RS measurements may be calculated and stored in various ways, and these measurements may be mapped to, or used to determine, one or more corresponding confidence scores. In one embodiment, for example, DCF-RS measurements may be calculated occasionally and reported to a centralized service. Over time, a DCF capabilities graph, which may comprise information and metadata about computing resources deployed in a DCF, may be generated/updated to contain pointers to time-series databases keeping these DCF-RCS measurements. In another embodiment, DCF-RS measurements may be stored as implicit DCF annotations as in the case where a DCF-RS measurement maps to a confidence score, or may be stored as explicit DCF annotations where the measurement itself comprises the confidence score, and in either case, the DCR-RS measurements may indicate indirectly (implicit) or directly (explicit) the resource consumption health of the node that is performing annotation as the data is flowing through that node. A DCF-RCS measurement may fall within, or outside, a specified range and designate a ‘healthy’ (within range) or ‘over-subscribed’ (out of range) condition depending upon where the DCF-RS measurement falls with respect to the range. Alternatively, a DCF-RCS measurement may be a Boolean that indicates, for a node, either ‘healthy’ or ‘over-subscribed.’

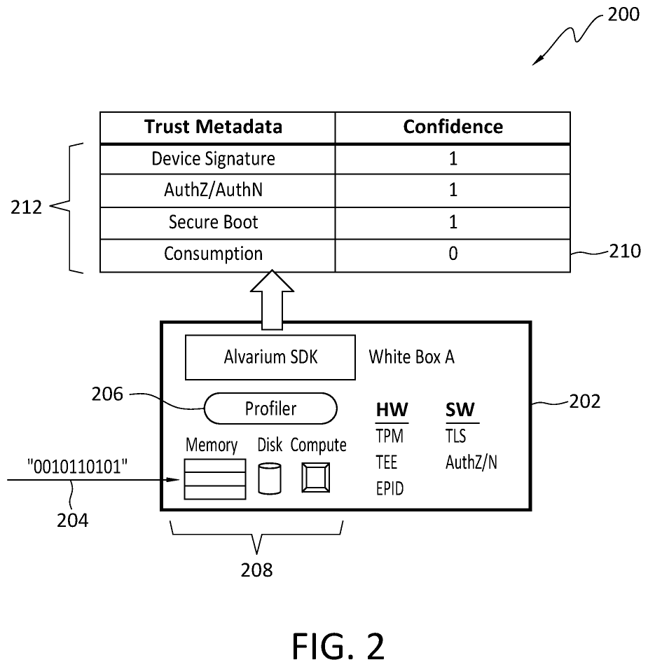

With reference now to FIG. 2, an example architecture 200 is disclosed for the example case where DCF-RS measurements are stored as DCF annotations that measure, or indicate, the resource consumption health of a node 202, such as a DCF node, that is performing annotation on data 204 as the data 204 is flowing through that node 202. In this example, the node 202 may comprise a profiler 206 that monitors resource consumption by the node 202, shown as ‘White Box A’ in the example of FIG. 2, and the profiler 206 may take notice when one or more of computing resources 208, such as memory, disk, and compute, for example, is/are being over-utilized. Thus, the profiler 206 may comprise information indicating respective acceptable ranges of consumption for each of the computing resources 208, against which resource consumption measurements taken/obtained by the profiler 206 may be compared.

In an embodiment, as the data 204 flows through a DCF, including node 202, the DCF may perform various annotations with respect to the data 204. For example, the DCF may annotate the data 204 to indicate that a ‘TPM’ has added a device signature and verified a secure boot, and to indicate that the ‘AuthZ/N’ software is currently in place, protecting against unauthorized access. However, a report from the profiler 206 may cause the generation and application, to the data 204, of a DCF annotation, which may be expressed as a Boolean (‘success’ or ‘failure’) rather than as an actual value of a resource consumption measurement, indicating that a consumption parameter has failed to meet its confidence criteria. That is, for example, overuse of a computing resource by the node 202 may result in a confidence score of zero (0) for a ‘consumption’ confidence parameter 210 that may be one of a group of confidence parameters 212, and associated values, that may be used to annotate the data 204. The confidence parameters 212 and their respective values may collectively form a set of trust metadata. As noted elsewhere herein, overuse of a computing resource may indicate a problem of some kind concerning the hardware/software configuration, and/or operation, of the node 202, and the existence of such a problem may thus be reflected in the zero (0) value for the ‘consumption’ confidence parameter 210.

In the illustrative example of FIG. 2, once resource consumption crosses a threshold, or is ‘out of range,’ confidence scores may begin to drop, or at least may not increase. As shown in the example of FIG. 2, and discussed earlier herein, the confidence score for the ‘consumption’ confidence parameter may be zero (0) and, as such, fails to increase the overall confidence score associated with the node 202. In an embodiment, the confidence score for the ‘consumption’ confidence parameter may be negative and, as such, may decrease the overall confidence score associated with the node 202.

In any case, a confidence score of zero (0) may indicate low/no confidence that the node 202 will be able to handle current/future workloads in a timely and effective manner. This information may be used to steer workloads away from node 202 to other nodes that are not oversubscribed in terms of their resource consumption. On the other hand, a confidence score of one (1) may indicate confidence that the node 202 is able to at least handle its current workloads, and possibly additional workloads. Thus, in an embodiment, DCF-RS measurements, and the associated confidence scores, may be used to enable workload allocation and workload balancing in a DCF.

Where DCF-RS measurements indicate overconsumption of one or more computing resources by a node, an admin or other operator may use this information to begin identifying and solving for a variety of problems. Thus, the DCF-RS measurements are not limited to use for confidence scoring, but may also be used for other purposes and applications as well. Some examples of questions that may be addressed through the use of DCF-RS measurements are set forth hereafter.

For example, is traffic that requires the use of node resources coming from the right resource—that is, is the node processing traffic that should have been directed to one or more other nodes instead? As another example, given that a node has a zero (0) confidence score for its resource consumption parameter, should one or more other nodes instead be used to service some or all of the traffic directed to the node with the zero (0) confidence score? Further, the use of DCF-RS measurements may help to determine whether or not a DCF environment, or a portion of it, is overly busy in terms of the amount of traffic/operations that are consuming computing resources. Related to that, an embodiment may also help determine whether new or replacement hardware is needed at the node. In an embodiment, a ‘heat map’ may be created that combines data confidence information with resource consumption scores. Such a heat map may be used to identify trouble spots in a DCF where resources are being overconsumed, or trending toward overconsumption, and confidence scores are correspondingly low. When the trouble spots are identified, adjustments to workload allocations, and hardware configurations, may be implemented to resolve any problems.

### C. Example Methods

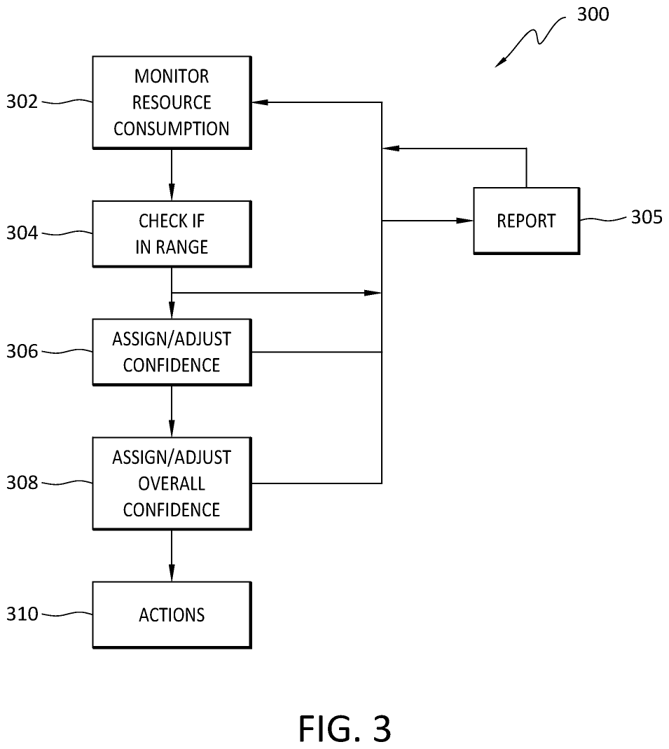

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method according to one embodiment of the invention is denoted at 300. In an embodiment, the method 300 may be performed, possibly in its entirety, at one or more nodes of a DCF, that is, a respective instantiation of the method 300 may be implemented at each node in a group of nodes. The method 300, which may be performed recursively, may begin at 302 with the monitoring of resource consumption at/by a node.

Periodically and/or on an ad hoc basis, or any other basis, a check 304 may be performed to determine if resource consumption is within a defined range. At this point, various alternatives may be possible, for any of which a report may be generated:
[1] if resource consumption had not previously been checked prior to the check 304, then a confidence score may be newly assigned to the resource consumption for the node—the method 300 may then continue to 308 where an overall confidence score for the node is updated to reflect the change in the confidence score for resource consumption;
[2] if resource consumption was within range both before and after the check 304, the method 300 may advance to 305 where a report may be generated indicating that consumption is within range, and the method 300 may then return to 302;
[3] if resource consumption was determined to be out of range prior to the check 304, and remains out of range at the time of the check 304, the method may advance to 305;
[4] if resource consumption was determined to be out of range prior to the check 304, but is in range at the time of the check 304, then the confidence score for resource consumption may be adjusted 306, and an overall confidence score for the node updated at 308; and
[5] if resource consumption was in range prior to the check 304, but is out of range at the time of the check 304, then the confidence score for resource consumption may be adjusted 306, and an overall confidence score for the node updated at 308.

Finally, one or more actions 310 may be taken based on values of and/or changes to a confidence score for resource consumption and/or an overall confidence score for the node. Such actions 310 may include, but are not limited to, adding or replacing hardware of the node, and balancing a workload in a DCF where the node is located.

### D. Further Example Embodiments

Following are some further example embodiments of the invention. These are presented only by way of example and are not intended to limit the scope of the invention in any way.
Embodiment 1. A method, comprising: monitoring, by a profiler at a node of a data confidence fabric, resource consumption of one or more resources by the node in connection with operations performed by the node; performing a check to determine if resource consumption by the node is within a specified range; and based on an outcome of the check, assigning, or adjusting, a confidence score for the resource consumption.
Embodiment 2. The method as recited in any preceding embodiment, wherein the one or more resources comprise one or more of memory, storage, processing, and power.
Embodiment 3. The method as recited in any preceding embodiment, wherein when the resource consumption is within the specified range, a first confidence score is applied to the resource consumption, and when the resource consumption is out of the specified range, a second confidence score is applied to the resource consumption, and the second confidence score is different from the first confidence score.
Embodiment 4. The method as recited in any preceding embodiment, wherein when the resource consumption is out of the specified range, a workload of the node is adjusted.
Embodiment 5. The method as recited in any preceding embodiment, wherein after the confidence score for the resource consumption is assigned, or adjusted, an overall confidence score for the node is assigned, or adjusted.
Embodiment 6. The method as recited in any preceding embodiment, wherein when the resource consumption is out of the specified range, the confidence score indicates that the node is oversubscribed and may not be able to perform a current, or future, workload.
Embodiment 7. The method as recited in any preceding embodiment, wherein when the resource consumption is out of the specified range, a workload directed to the node is redirected to another node.
Embodiment 8. The method as recited in any preceding embodiment, wherein performing a check comprises measuring consumption of a particular resource by the node.
Embodiment 9. The method as recited in any preceding embodiment, wherein when the resource consumption is out of the specified range, a check is performed to determine if the node is functioning correctly.
Embodiment 10. The method as recited in any preceding embodiment, wherein performing a check comprises measuring consumption of a particular resource by the node, and measurements of the consumption of that particular resource are stored at the node.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

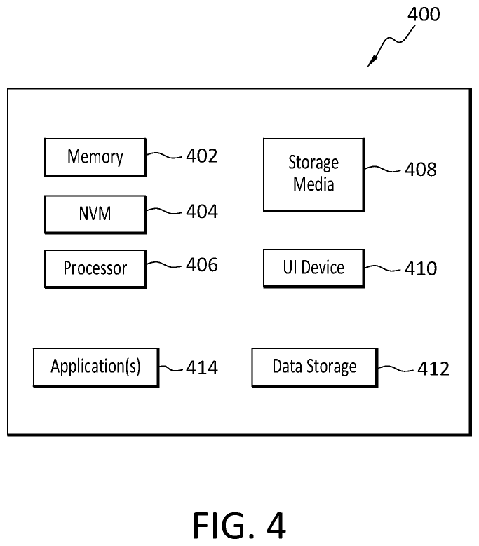

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
monitoring, by a profiler at a node of a data confidence fabric, resource consumption of one or more resources by the node in connection with operations performed by the node;
performing a check to determine if resource consumption by the node is within a specified range; and
based on an outcome of the check, assigning, or adjusting, a confidence score for the resource consumption.

2. The method as recited in claim 1, wherein the one or more resources comprise one or more of memory, storage, processing, and power.

3. The method as recited in claim 1, wherein when the resource consumption is within the specified range, a first confidence score is applied to the resource consumption, and when the resource consumption is out of the specified range, a second confidence score is applied to the resource consumption, and the second confidence score is different from the first confidence score.

4. The method as recited in claim 1, wherein when the resource consumption is out of the specified range, a workload of the node is adjusted.

5. The method as recited in claim 1, wherein after the confidence score for the resource consumption is assigned, or adjusted, an overall confidence score for the node is assigned, or adjusted.

6. The method as recited in claim 1, wherein when the resource consumption is out of the specified range, the confidence score indicates that the node is oversubscribed and may not be able to perform a current, or future, workload.

7. The method as recited in claim 1, wherein when the resource consumption is out of the specified range, a workload directed to the node is redirected to another node.

8. The method as recited in claim 1, wherein performing a check comprises measuring consumption of a particular resource by the node.

9. The method as recited in claim 1, wherein when the resource consumption is out of the specified range, a check is performed to determine if the node is functioning correctly.

10. The method as recited in claim 1, wherein performing a check comprises measuring consumption of a particular resource by the node, and measurements of the consumption of that particular resource are stored at the node.

11. A non-transitory storage medium having stored therein instructions that are executable by one or more hardware processors to perform operations comprising:
monitoring, by a profiler at a node of a data confidence fabric, resource consumption of one or more resources by the node in connection with operations performed by the node;
performing a check to determine if resource consumption by the node is within a specified range; and
based on an outcome of the check, assigning, or adjusting, a confidence score for the resource consumption.

12. The non-transitory storage medium as recited in claim 11, wherein the one or more resources comprise one or more of memory, storage, processing, and power.

13. The non-transitory storage medium as recited in claim 11, wherein when the resource consumption is within the specified range, a first confidence score is applied to the resource consumption, and when the resource consumption is out of the specified range, a second confidence score is applied to the resource consumption, and the second confidence score is different from the first confidence score.

14. The non-transitory storage medium as recited in claim 11, wherein when the resource consumption is out of the specified range, a workload of the node is adjusted.

15. The non-transitory storage medium as recited in claim 11, wherein after the confidence score for the resource consumption is assigned, or adjusted, an overall confidence score for the node is assigned, or adjusted.

16. The non-transitory storage medium as recited in claim 11, wherein when the resource consumption is out of the specified range, the confidence score indicates that the node is oversubscribed and may not be able to perform a current, or future, workload.

17. The non-transitory storage medium as recited in claim 11, wherein when the resource consumption is out of the specified range, a workload directed to the node is redirected to another node.

18. The non-transitory storage medium as recited in claim 11, wherein performing a check comprises measuring consumption of a particular resource by the node.

19. The non-transitory storage medium as recited in claim 11, wherein when the resource consumption is out of the specified range, a check is performed to determine if the node is functioning correctly.

20. The non-transitory storage medium as recited in claim 11, wherein performing a check comprises measuring consumption of a particular resource by the node, and measurements of the consumption of that particular resource are stored at the node.
